(19) United States
(12) Patent Application Publication
(10) Pub. No.: US 2026/0072637 A1
(43) Pub. Date: Mar. 12, 2026

(54) MULTI-TRACK RECORDING FOR PORTABLE ELECTRONIC DEVICES

(71) Applicant: Apple Inc., Cupertino, CA (US)

(72) Inventors: Sarmad Aziz MALIK, Cupertino, CA (US); Alec H. LITTLE, Woodside, CA (US); Daniel P. PATTERSON, San Jose, CA (US); Joshua D. ATKINS, Lexington, MA (US); Merilou G. SALAZAR, Marina Del Rey, CA (US); Sascha HÖHNE, Hamburg (DE); Mehrez SOUDEN, Los Angeles, CA (US)

(21) Appl. No.: 19/271,681

(22) Filed: Jul. 16, 2025

Related U.S. Application Data
(60) Provisional application No. 63/692,030, filed on Sep. 6, 2024.

(51) Int. Cl. G06F 3/16; H04M 9/08

(52) U.S. Cl. CPC G06F 3/165; H04M 9/082

(57) ABSTRACT

Systems, devices, and methods for multi-track recording are provided. Multi-track recording may include outputting, using a speaker of a device, a first track that was previously recorded by that device, while receiving a new audio input with two or more microphones of that device. Because the output of the first track may also be received by the two or more microphones, the device may then use the new audio input to one of the microphones to cancel content corresponding to the first track in the new audio input to another of the microphones. In this way, a new track including substantially only the new audio input may be generated and stored.

### CROSS REFERENCE TO RELATED APPLICATIONS

This application claims the benefit of priority to U.S. Provisional Patent Application No. 63/692,030, entitled, “Multi-Track Recording for Portable Electronic Devices”, filed on Sep. 6, 2024, the disclosure of which is hereby incorporated herein in its entirety.

### TECHNICAL FIELD

The present description relates generally to electronic devices including, for example, to multi-track recording for portable electronic devices.

### BACKGROUND

Electronic devices are often used as voice recorders, such as when a user speaks into a voice recorder application on a smartphone to record a quick note, or to record, with explicit authorization from all parties being recorded, a conversation or meeting between one or more people.

### BRIEF DESCRIPTION OF THE DRAWINGS

Certain features of the subject technology are set forth in the appended claims. However, for purpose of explanation, several aspects of the subject technology are set forth in the following figures.

FIG. 1 illustrates an example system architecture including various electronic devices that may implement the subject system in accordance with one or more implementations.

FIG. 2 illustrates an example of an electronic device performing multi-track recording in accordance with implementations of the subject technology.

FIG. 3 illustrates another example of an electronic device performing multi-track recording in accordance with implementations of the subject technology.

FIG. 4 illustrates an example of an electronic device recording an initial track in accordance with implementations of the subject technology.

FIG. 5 illustrates operations that may be performed by an application at an electronic device for making a multi-track recording in accordance with implementations of the subject technology.

FIG. 6 illustrates an example user interface that includes a selectable option to record a second track after recording of a first track in accordance with implementations of the subject technology.

FIG. 7 illustrates an example user interface for initiation of recording of a second track after recording of a first track in accordance with implementations of the subject technology.

FIG. 8 illustrates an example user interface during recording of a second track after recording of a first track in accordance with implementations of the subject technology.

FIG. 9 illustrates an example user interface for selecting tracks from among multiple recorded tracks in a multi-track recording in accordance with implementations of the subject technology.

FIG. 10 illustrates an example user interface that includes a selectable option to replace and/or mix one or more of multiple recorded tracks in a multi-track recording in accordance with implementations of the subject technology.

FIG. 11 illustrates an example user interface with an indicator that a recording is a multi-track recording that includes multiple tracks in accordance with implementations of the subject technology.

FIG. 12 illustrates an example user interface that includes a controller for controlling relative amounts of multiple recorded tracks in a multi-track recording in accordance with implementations of the subject technology.

FIG. 13 illustrates an example of another electronic device performing multi-track recording in accordance with implementations of the subject technology.

FIG. 14 illustrates an example of an electronic device performing echo cancellation during a telephony operation in accordance with implementations of the subject technology.

FIG. 15 illustrates a flow diagram for an example process for multi-track recording in accordance with implementations of the subject technology.

FIG. 16 illustrates a flow diagram for another example process for multi-track recording in accordance with implementations of the subject technology.

FIG. 17 illustrates an electronic system with which one or more implementations of the subject technology may be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

Aspects of the subject disclosure can provide multi-track recording for compact devices, such as handheld devices (e.g., smartphones, tablets, or other devices with one or more speakers and more than one microphone). Multi-track recording may be provided in which multiple tracks of a multi-track recording can be recorded at separate times using a single device, and in which one or more earlier recorded tracks are output by the device while recording a later track. For example, playback of one or more previously recorded tracks may be output by one or more speakers of a device, while a new track is being recorded with one or more microphones of that same device (e.g., without the use of headphones, separate from the recording device, to prevent the output of the previously recorded track(s) from being re-recorded in the new track). For example, as described in further detail hereinafter, the multi-track recording operations disclosed herein may include cancellation of the audio content of the previously recorded track(s) being output by the device from the new audio input for the new track, so that a new single track can be recorded. As described in further detail hereinafter, in one or more implementations, the cancellation may be followed by further suppression of (e.g., residual or uncancelled portions of) the audio content of the previously recorded track(s) from the new audio input for the new track. For example, the suppression may be performed by a trained machine learning model (e.g., running on a neural processor or other processor) in one or more implementations.

In one or more implementations, the disclosed technology enables multi-track recording with a single application. In this way, a user may be provided with the ability to, for example, play an instrument while recording themselves with their smartphone or other personal or portable device, and to later playback the recording of themselves playing the instrument through a speaker of their smart phone or other personal or portable device while recording, in a separate track, themselves singing over the playback (and/or playing another instrument over the playback). In various examples herein, a track may refer to an audio track that includes information representing sound. However, it is appreciated that one or more audio tracks may be recorded (e.g., using a camera application or a communications application such as a video conferencing application) along with a video track (e.g., video may be recorded along with one or more of the audio tracks).

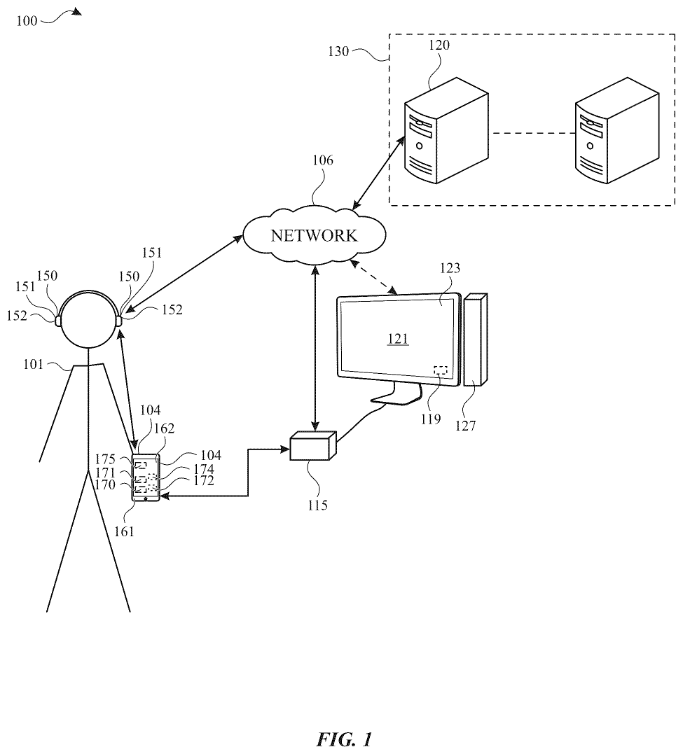

FIG. 1 illustrates an example system architecture 100 including various electronic devices that may implement the subject system in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The system architecture 100 includes an audio output device 150, an electronic device 104 (e.g., a handheld electronic device such as a smartphone or a tablet, or a wearable electronic device such as a smart watch or a head worn device), a media output device 115 (e.g., a set top box or the like), a display device 123 (e.g., a television, monitor, or other device with a display and/or one or more speakers), a speaker device 127 (e.g., a wired or wireless speaker, such as a Bluetooth speaker or a smart speaker), and/or one or more servers 120 communicatively coupled by a network 106 (e.g., a local or wide area network). For explanatory purposes, the system architecture 100 is illustrated in FIG. 1 as including the audio output device 150, the electronic device 104, the media output device 115, the display device 123, the speaker device 127, and the server(s) 120; however, the system architecture 100 may include any number of electronic, media output, speaker, display, and/or audio output devices and any number of servers and/or a data centers including multiple servers.

As shown in FIG. 1, the electronic device 104 may including processing circuitry 170, one or more speakers 172 (e.g., and/or one or more other audio output components including other speakers), one or more microphones 174, one or more cameras 175, and/or other components (e.g., memory, displays, batteries, etc.), which may be disposed within and/or otherwise mounted to a housing 161 of the electronic device 104. The electronic device 104 may be, for example, a compact and/or portable electronic device, such as a smartphone, a tablet device, a laptop computer, a desktop computer, a wearable device such as a smart watch, a smart band, a head mountable device, and the like, a peripheral device (e.g., a digital camera, headphones, an audio device, or an audio output device), any other appropriate device that includes, for example, one or more speakers 172, one or more microphones 174, and/or processing circuitry 170 (e.g., for generating audio outputs with the one or more speakers 172 and/or processing audio inputs captured using the one or more microphones 174). As shown, the electronic device 104 may also include memory 171 for storing audio content, such as one or more tracks of an audio recording captured using the one or more microphones 174. In one or more implementations, the electronic device 104 may also include a display 162, and/or may include communications circuitry for providing audio content to audio output device(s) 150, for receiving audio inputs from the audio output device(s) 150, and/or for providing audio content to the media output device 115. In FIG. 1, by way of example, the electronic device 104 is depicted as a mobile smartphone device.

The audio output device 150 may be implemented as a wireless audio output device such as a smart speaker, a wearable audio output device such as headphones (e.g., a pair of speakers mounted in speaker housings that are coupled together by a headband) or an earbud (e.g., an earbud of a pair of earbuds each having a speaker disposed in a housing that conforms to a portion of the user's ear) configured to be worn by a user 101 (also referred to as a wearer when the wireless audio output device is worn by the user), or may be implemented as any other device capable of outputting audio and/or video and/or other types of media (e.g., and configured to be worn by a user). Each audio output device 150 may include one or more audio output components such as one or more speakers 151 configured to project sound into (e.g., directly into) an car of the user 101, and one or more microphones, such as microphones 152. The audio output device 150 may be communicatively coupled to the electronic device 104 and/or the media output device 115, such as via the network 106 or via a direct wireless connection, such as a Bluetooth connection or a direct WiFi connection. In one or more implementations, the audio output device 150 may be communicatively coupled to the network 106 via the connection with the electronic device 104. In one or more other implementations, the audio output device 150 may optionally be capable of connecting directly to the network 106 (e.g., without a connection to the electronic device 104).

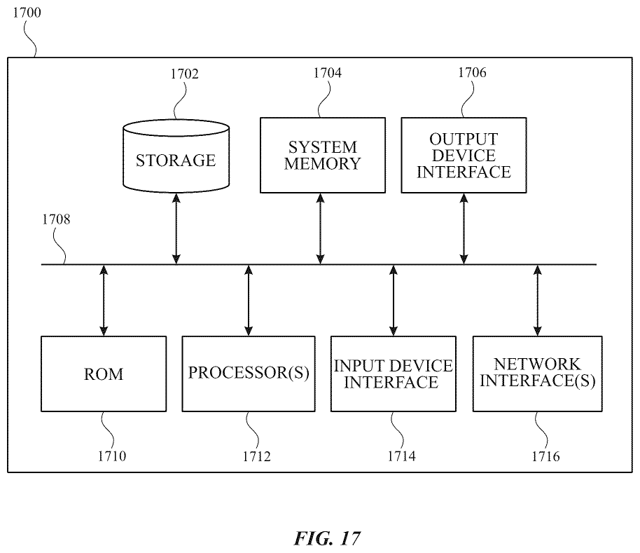

In one or more implementations, the audio output device 150 may also include other components, such as one or more inertial sensors and/or one or more display components (not shown) for displaying video or other media to a user. Although not visible in FIG. 1, each audio output device 150 may include processing circuitry (e.g., including memory and/or one or more processors) and communications circuitry (e.g., one or more antennas, etc.) for receiving and/or processing audio content from the electronic device 104 or another electronic device. The processing circuitry of the audio output device 150 may operate the speaker 151 to generate sound (also referred to herein as audio output) corresponding to audio content received from the electronic device 104. The processing circuitry of the audio output device 150 may operate the microphone(s) 152 to receive audio inputs including voices and/or music, and may process the audio inputs as described herein. The audio output device may include a power source such as a battery and/or a wired or wireless power source. As shown in FIG. 1, the audio output device 150 may include a housing that is physically separate from the housing of the electronic device, and the speaker(s) 151 and/or the microphones 152 (e.g., and/or other components such as memory, processor(s), communications circuitry, or the like) may be disposed within or otherwise mounted to the housing of the audio output device 150. In one or more implementations, the electronic device 104 and/or the audio output device 150 may be, and/or may include all or part of, the electronic device discussed below with respect to the electronic system discussed below with respect to FIG. 17.

The electronic device 104, the media output device 115, the display device 123, the speaker device 127, and/or the server 120 may include communications circuitry for communications (e.g., directly or via network 106) with audio output device 150 and/or with the others of the electronic device 104, the media output device 115, the display device 123, the speaker device 127, and/or the server 120, the communications circuitry including, for example, one or more wireless interfaces, such as WLAN radios, cellular radios, Bluetooth radios, Zigbee radios, near field communication (NFC) radios, and/or other wireless radios. The audio output device 150 may include communications circuitry for communications (e.g., directly or via network 106) with the electronic device 104, the media output device 115, and/or the server 120, the communications circuitry including, for example, one or more wireless interfaces, such as WLAN radios, cellular radios, Bluetooth radios, Zigbee radios, near field communication (NFC) radios, and/or other wireless radios.

As shown in FIG. 1, the display device 123 may include one or more speakers 119 and/or a display 121. In the example of FIG. 1, the display device 123 is connected to the media output device 115 by a wired connection (e.g., an HDMI or other wired connection). However, in other implementations, display device 123 may be connected to the media output device 115 via a wireless connection (e.g., via the network 106 or directly). In one or more implementations, the speaker device 127 may output music and/or other audio content received via the display device 123, or directly, from the electronic device 104 and/or the media output device 115.

In one or more implementations, the electronic device 104 and/or the media output device 115 may include memory (e.g., volatile or non-volatile memory) that stores audio content, such as a music library containing one or more audio files, one or more of which may correspond to a recording, such as a single track recording or a multi-track recording. For example, one or more tracks that were previously recorded using the electronic device 104 and/or the audio output device 150 may be stored in the memory of the electronic device 104 and/or the media output device 115. In one or more implementations, the electronic device 104 and/or the media output device 115 may include one or more applications, such as recording applications, such as a voice recorder application, a camera application, or a voice memo application, and/or a communication application (e.g., a telephony application, an audio conferencing application, or a video conferencing application).

In one or more implementations, the electronic device 104, the audio output device, 150, the speaker device 127, the display device 123, and/or the media output device 115 may output one or more previously recorded tracks (e.g., using the speaker(s) 172 of the electronic device 104, the speaker(s) 119 of the display device 123, the speaker device 127, the speakers 151 of the audio output device 150, and/or any other speaker that is communicatively coupled to, the electronic device 104, the audio output device, 150, the speaker device 127, the display device 123, and/or the media output device 115. The output of the previously recorded track(s) may be projected into the environment of the user, and may be received by one or more microphones of the electronic device 104, the audio output device, 150, the speaker device 127, the display device 123, and/or the media output device 115, such as while the one or more microphones of the electronic device 104, the audio output device, 150, the speaker device 127, the display device 123, and/or the media output device 115 are also receiving new audio input for a new track.

The server(s) 120 may form all or part of a network of computers or a group of servers for a remote service 130, such as in a cloud computing or data center implementation. For example, the server(s) 120 may store data (e.g., audio content) and software, and include specific hardware (e.g., processors, graphics processors and other specialized or custom processors) storing, curating, and/or streaming audio content to network-connected devices, such as the electronic device 104.

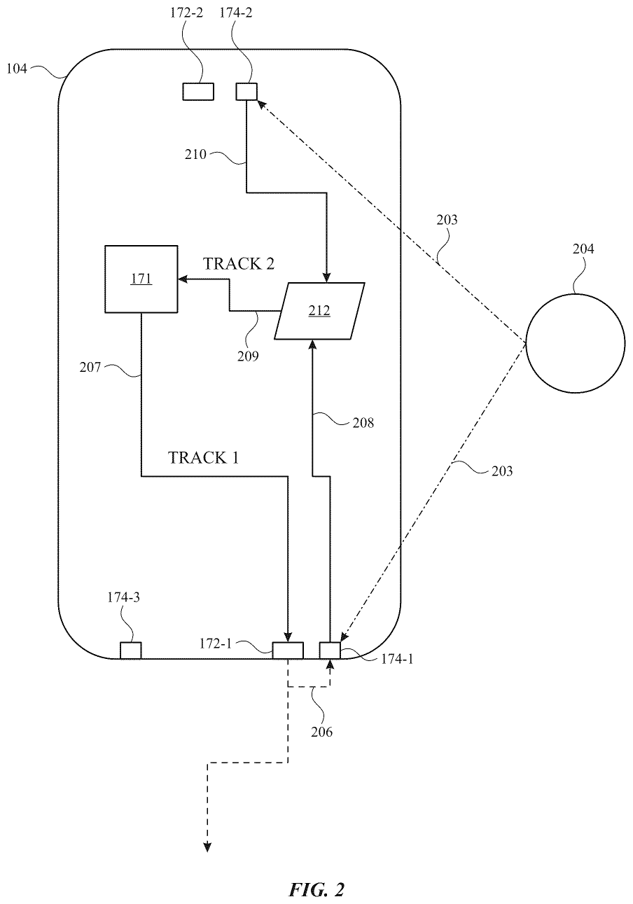

FIG. 2 illustrates aspects of an example in which the electronic device 104 performs a multi-track recording operation. In the example of FIG. 2, rectangular elements may represent hardware components, and trapezoidal elements may represent processes that may be implemented in hardware, software, or a combination thereof. In the example of FIG. 2, the electronic device 104 includes a speaker 171-1 (e.g., a first speaker, such as a bottom speaker), and a speaker 172-2 (e.g., a second speaker, such as a top speaker). In the example of FIG. 2, the electronic device 104 includes a microphone 174-1 (e.g., a first microphone, such as a bottom microphone), a microphone 174-2 (e.g., a second microphone, such as a top microphone), and a microphone 174-3 (e.g., a third microphone). Although two speakers and three microphones are depicted in FIG. 2, this is merely illustrative and the electronic device 104 may include fewer than two speakers, more than two speakers, fewer than three microphones, or more than three microphones, in various implementations. As shown in the example of FIG. 2, the microphone 174-1 may be nearer to the speaker 172-1 than to the speaker 172-2, and the microphone 174-2 may be nearer to the speaker 172-2 than to the speaker 172-1.

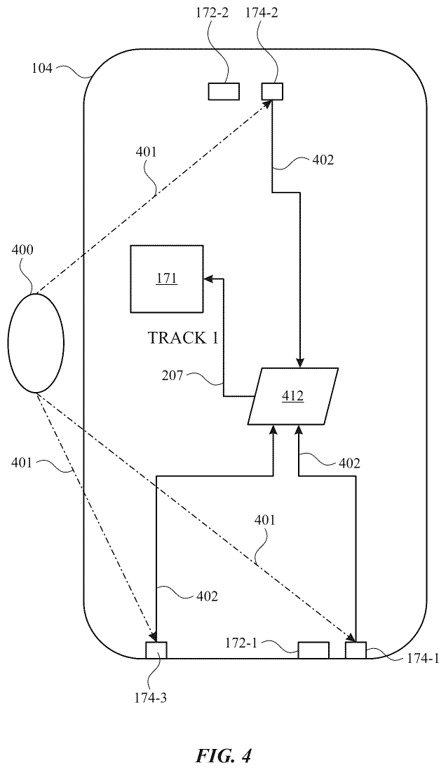

In the example of FIG. 2, speaker 172-1 generates an audio output 206. In this example, the audio output 206 includes the audio content of a track 207 (e.g., a first track, labeled TRACK 1 in the figure). As shown, the track 207 has been previously stored in the memory 171 of the electronic device 104. As discussed in further detail hereinafter (see, e.g., FIG. 4), the track 207 may have been previously recorded by the electronic device 104, and stored in the memory 171.

As shown, the audio output 206 may exit the electronic device 104 (e.g., to be heard by a user (e.g., user 101), and may also be received by the microphone 174-1 that is in proximity to (e.g., within five centimeters, within two centimeters, within one centimeter, within fifty millimeters, within twenty millimeters, or within ten millimeters of) the speaker 172-1. As shown, an audio input 208 may be generated by the microphone 174-1 and provided to a processing block 212. In one or more examples discussed herein, the audio input 208 may be referred to as a first audio input and/or as a reference audio signal.

In the example of FIG. 2, a sound source 204 generates sound 203 while the speaker 172-1 outputs the audio output 206. As one illustrative example, the sound source 204 may be a person, such as the user 101 of the electronic device 104 (e.g., a voice of the person, while the person is speaking and/or singing). As another illustrative example, the sound source 204 may be an instrument played by a person, such as the user 101 of the electronic device 104. As illustrated in the figure, the sound 203 may be received by the microphone 174-1 and the microphone 174-2. As shown, an audio input 210 may be generated by the microphone 174-2 and provided to the processing block 212.

Because the audio output 206 and the sound 203 are received (e.g., substantially concurrently) by the microphone 174-1 and (e.g., substantially concurrently) by the microphone 174-2, the audio input 208 and the audio input 210 may each include audio content corresponding to the audio output 206 and audio content corresponding to the sound 203. However, because the microphone 174-1 is proximate to the speaker 172-1, the audio input 208 may primarily include the audio content corresponding to the audio output 206 of the speaker 172-1 (e.g., audio content corresponding to the previously recorded track 207). Because the microphone 174-1 is further from the speaker 172-1, the audio input 210 may include a more even or balanced mix of audio the content corresponding to the audio output 206 of the speaker 172-1 (e.g., audio content corresponding to the previously recorded track 207) and the audio content corresponding to the sound 203, or may predominantly include the audio content corresponding to the sound 203. In one or more implementations, the audio input 208 and the audio input 210 may be used to generate spatial information for the audio content corresponding to the sound 203 (e.g., to determine a direction of arrival of the sound 203, and/or a distance to the sound source 204) for spatial recording of the sound 203 (e.g., for later spatial playback of the sound 203).

It may be desirable to record a track (e.g., an audio track) that includes only, or primarily (e.g., substantially only), the audio content corresponding to the sound 203, without including the audio content corresponding to the audio output 206 (e.g., audio content corresponding to the previously recorded track 207). In the example of FIG. 2, the processing block 212 may use the audio input 208 to remove (e.g., cancel) the portion of the audio input 210 that corresponds to the audio output 206. In this way, the processing block 212 may generate a track 209 (e.g., a second track, labeled TRACK 2 in the figure) that includes only, or primarily, the audio content corresponding to the sound 203, without including the audio content corresponding to the audio output 206. In one or more implementations, the processing block 212 may be an echo canceller that is configured to cancel a portion of one input signal (e.g., a portion of the audio input 210) based on a representation of that portion of the one input signal in another input signal (e.g., the audio input 208). As discussed in further detail hereinafter, the echo canceller may, at one or more times, be used by other processes of the electronic device, such as during a telephone call or audio conference in which the echo canceller cancels a portion of a microphone signal that corresponds to a voice of a remote caller being output by the speaker(s) of the electronic device, to allow the voice of the user of the electronic device to be transmitted to the remote caller without an echo of the remote caller's own voice.

As illustrated in FIG. 2, the track 209 may be provided from the processing block 212 to the memory 171 for storage. For example, the track 209 may be stored, along with the track 207, in a multi-track recording. In one or more implementations, the operations depicted in FIG. 2 may be repeated for recording of one or more additional (e.g., third, fourth, etc.) tracks, such as by outputting the track 207, the track 209, and/or both the track 207 and the track 209 with the speaker 172-1, providing an additional audio input to the microphones 174-1 and 174-2, and removing (e.g., cancelling) the portion of the additional audio input received by the microphone 174-2 using the additional audio input received by the microphone 174-1, to generate the additional (e.g., third, fourth, etc.) track.

As illustrated in FIG. 2, during a multi-track recording operation, in which audio output 206 is generated by the speaker 172-1 while recording the sound 203 with the microphones 174-1 and 174-2, one or more other speakers, such as the speaker 172-2 of the electronic device 104, may be muted or otherwise inactivated or prevented from generating an audio output. In this way, the audio input 210 generated by the microphone 174-2 may be prevented from being dominated by the audio content of track 207, to facilitate the removal of a smaller representation of the audio content of track 207 in the audio input 210.

Although the processor(s) of the electronic device 104 are not depicted in FIG. 2 for emphasis on the operations described above, the operations illustrated in FIG. 2 may be controlled by one or more processors (e.g., one or more processors of processing circuitry 170) of the electronic device 104 (e.g., executing an application, such as a voice memo recorder application, a camera application, a telephony application, an audio conferencing application, a video conferencing application, or another application).

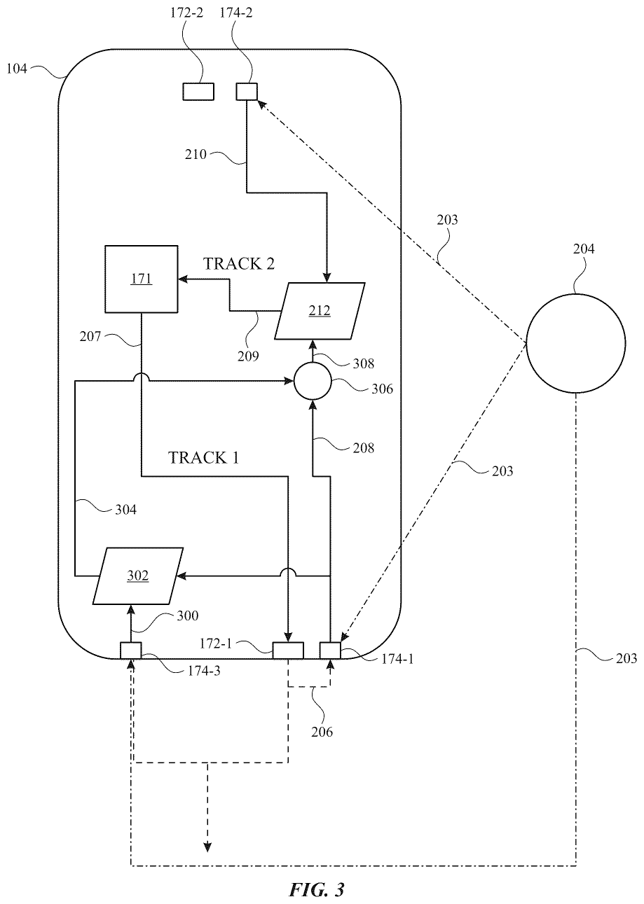

In one or more use cases, because the audio input 208 will include some input based on the sound 203, the removal (e.g., cancelation) operation performed by the processing block 212 may unintentionally remove (e.g., cancel) some of the recorded representation of the sound 203 in the audio input 210. In order to reduce or prevent the unintentional removal (e.g., cancelation) of some of the recorded representation of the sound 203 in the audio input 210, the electronic device 104 may also perform a masking operation, as illustrated in FIG. 3, in one or more implementations.

As shown in FIG. 3, a masking block 302 at the electronic device 104 may receive the audio input 208 from the microphone 174-1 and an audio input 300 from another microphone 174-3 at the electronic device 104. For example, the audio input 300 may include audio content corresponding to both the audio output 206 and the sound 203. Because the microphone 174-3 is further from the speaker 172-1 than the microphone 174-1 is from the speaker 172-1, the amount of audio content corresponding to the audio output 206 in the audio input 300 may be lower than the amount of audio content corresponding to the audio output 206 in the audio input 208, and the amount of audio content corresponding to the sound 203 in the audio input 300 may be substantially the same as, or higher than, the amount of audio content corresponding to the sound 203 in the audio input 208. The masking block 302 may identify (e.g., using the audio input 208 and the audio input 300, such as by comparing the audio input 208 and the audio input 300) the portions (e.g., in frequency and/or time) of the audio input 300 that correspond to the sound 203, and may generate a mask 304 (e.g., in frequency space and/or time space) that identifies those portions. As shown, the mask 304 may be applied (e.g., at a mixing block 306) to the audio input 208. For example, applying the mask 304 to the audio input 208 may remove some or all of the portions of the audio input 208 corresponding to the sound 203. Applying the mask 304 to the audio input 208 may generate a masked audio input 308 that may be used by the processing block 212 (e.g., echo canceller) as a reference signal to remove (e.g., cancel) only the portion of the audio input 210 that corresponds to the audio output 206.

As discussed herein, in one or more implementations, the track 207 may be a previously recorded track, recorded using the electronic device 104. FIG. 4 illustrates an example in which the electronic device 104 is used to record the track 207. In the example of FIG. 4, a sound source 400 generates sound 401. As illustrative examples, the sound source 400 may be the user 101 of the electronic device 104 (e.g., a voice of the user while the user is singing and/or speaking), or an instrument being played by the user 101 or another person in the vicinity of the electronic device 104. As shown, the sound 401 may be received by one or more of the microphones of the electronic device 104, such as the microphone 174-1, the microphone 174-2, and/or the microphone 174-3. As shown, the sound 401 may be received by the microphone(s) of the electronic device 104 at one or more respective times during which no audio output is being generated by the speakers of the electronic device 104. As shown, responsive to receiving the sound 401, the microphones of the electronic device 104 may generate audio inputs 402 (e.g., which may include spatial information indicating the spatial location of the sound source 400) and provide the audio inputs 402 to a processing block 412. Processing block 412 may include, for example, one or more operations performed by an application (e.g., a voice memo application, a camera application, or a communication application such as a telephony application, an audio conferencing application, or a video conferencing application), running at the electronic device 104. As shown, the processing block 412 may process the audio inputs 402 to generate the track 207, and provide the track 207 to memory 171 for storage. Because the audio inputs 402 are received while the speakers of the electronic device 104 are inactive, the processing block 412 may generate the track 207 without performing echo cancellation operations.

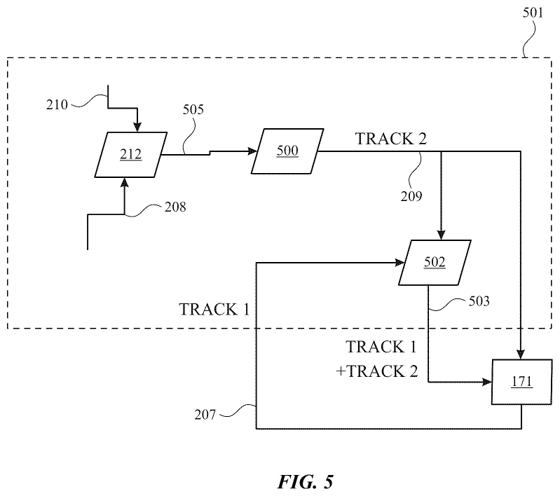

In one or more implementations, following echo cancellation operations performed by the processing block 212 in the examples of FIG. 2 or 3, the electronic device 104 may perform one or more additional operations on the echo-canceled output of the processing block 212. For example, FIG. 5 illustrates aspects of a process in which an echo-canceled output 505 of the processing block 212 is provided to a processing block 500. The processing block 500 may perform one or more post-processing operations on the echo-canceled output 505 of the processing block 212. For example, the processing block 500 may perform residual echo cancellation operations on the echo-canceled output 505 of the processing block 212, to generate the track 209. For example, in one or more use cases, the echo cancellation process of the processing block 212 may remove most (e.g., more than 90%, more than 95%, or more than 99%) of the audio content corresponding to the audio output 206 from the audio input 210, leaving a relatively smaller residual echo of the audio output 206 in the echo canceled output of the processing block 212.

In one or more implementations, the processing block 500 may be implemented as a machine learning model that has been trained to suppress a residual echo portion of an audio signal. For example, as shown in FIG. 5, an echo-cancelled output 505 of the processing block 212 may be provided as one of one or more inputs to the machine learning model corresponding to the processing block 500. In one or more implementations, the audio input 208, the audio input 210, the track 207, and/or other signals and/or data may also be provided (e.g., from the processing block 212 and/or the memory 171) to the processing block 500 (e.g., the machine learning model) as inputs. Responsive to receiving the input(s) (e.g., from the processing block 212 and/or the memory 171), the machine learning model corresponding to the processing block 500 may suppress a residual echo portion of the echo-cancelled output 505, and provide, as an output of the machine learning model, the track 209 (e.g., an echo-cancelled and residual-echo-suppressed audio track).

As shown in FIG. 5, the track 209 may be provided to the memory 171 for storage, as described above herein. FIG. 5 also shows how the track 209 may be provided to an additional processing block 502. In one or more implementations, the processing block 502 may combine the track 207 and the track 209 to form a multi-track recording 503. As shown, the multi-track recording 503 may also be provided to the memory 171 for storage.

As indicated in FIG. 5, in one or more implementations, the operations of the processing block 212, the processing block 500, and the processing block 502 may be operations of single application 501 (e.g., running at the electronic device 104 or another electronic device). In one or more implementations, the same application 501 that performs the operations of the processing block 212, the processing block 500, and the processing block 502 to generate a multi-track recording may be used to record a first track (e.g., a previously recorded track, such as track 207, as described in connection with FIG. 4). The application 501 may be stored in the memory 171 and/or other memory at the electronic device 104 (or another electronic device), and may be executed (e.g., by one or more processors of processing circuitry 170) to perform any or all of the multi-track recording operations (e.g., first track recording, second track recording, and/or additional track recording operations) and/or processes described herein. In one or more other implementations, some operations of the processing block 212, the processing block 500, and/or the processing block 502 may be performed outside of the application 501. For example, the processing block 212 may be implemented as a digital signal processor that is accessible to a multi-track recording application, a telephony application, and/or other applications and/or functions of the electronic device on which the processing block 212 is installed. For example, the application 501 may provide the audio input 208 and the audio input 210 to the processing block 212 outside the application 501, and receive the echo-cancelled output 505 from the processing block 212 for further processing by the processing block 500 (e.g., within the application or outside the application).

In the example of FIG. 5, the processing block 212 is described as an echo canceller that generates an echo-cancelled output 505 that may be provided to one or more additional processing blocks, such as the processing block 500 and/or the processing block 502. In one or more other examples, the processing block 212 may have capabilities (e.g., deterministically programmed capabilities, and/or trained machine learning capabilities) beyond echo cancellation and/or suppression, including, as examples, spatial signal extraction for multi-channel spatial capture and/or targeted extraction of various types of audio signals (e.g., including but not limited to, detection and/or storage of individual tracks from specific kinds to instruments, vocals, etc.). In this way, the processing block 212 can extract and store information for providing a user (e.g., and/or a subsequent processing block, such as the processing block 500 and/or the processing block 502) with a better understanding of the music being recorded, such as for easier and/or more advanced and/or flexible remixing of the various recorded tracks (e.g., recorded at various different times and/or extracted by the processing block 212 into multiple targeted tracks from a single recorded input).

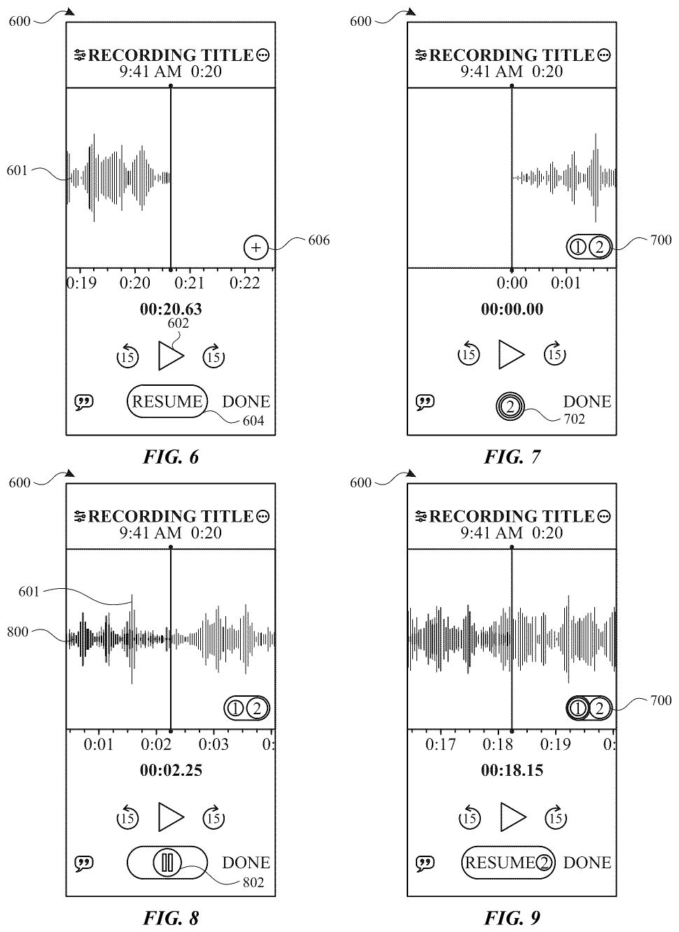

In one or more implementations, an electronic device, such as the electronic device 104, that is used to perform multi-track recording as described herein may provide a user interface to facilitate multitrack recording for a user of the electronic device. For example, FIG. 6 illustrates a view of a user interface 600 (e.g., a user interface of the application 501) that may be provided (e.g., on a display 162 of the electronic device 104, or a display of another electronic device) for multi-track recording. In the example of FIG. 6, the user interface 600 includes a representation (e.g., a waveform representation) of a previously recorded track (e.g., a first track, such as track 207, that was previously recorded using the electronic device on which the user interface 600 is displayed and on which the application corresponding to the user interface is running). As shown, the user interface 600 may include an option 602 to playback the previously recorded track, an option 604 to resume recording of the previously recorded track, and an option 606 to add a new track.

As shown in FIG. 7, after selection of the option 602 to add a new track, the user interface 600 may be updated to include a selector 700 for selecting between multiple tracks, and a record button 702 that is selectable to initiate recording of the new track (e.g., track 209). As shown in FIG. 8, following selection of the record button 702, the user interface 600 may be updated to display an updating representation 800 (e.g., a waveform representation) of the new track that is being recorded (e.g., using the playback, echo cancellation, masking, and/or residual echo suppression operations described herein in connection with FIGS. 2, 3, and/or 5). The user interface 600 may also include a pause button 802 for pausing the recording of the new track. As shown, the updating representation 800 of the new track may be overlaid on (e.g., an aligned in time with) the representation 601 of the previously recorded track that is being output by the speaker(s) of the electronic device that is recording the new track.

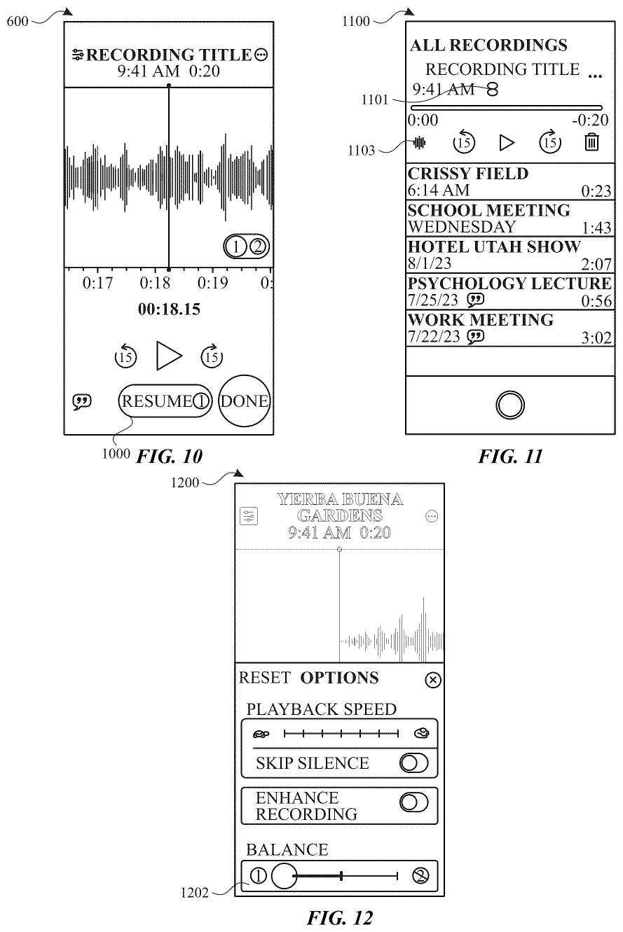

As shown in FIG. 9, after recording of the new track has been completed or paused, the selector 700 may be used to select between the multiple recorded tracks (e.g., the newly recorded track 1, and the previously recorded track 2), such as for resuming recording or for initiating playback of the selected track. As shown in FIG. 10, after recording of the new track has been completed or paused, and selector 700 has been used to select the previously recorded track, the user interface 600 may be updated to include an option 1000. For example, option 1000 may be an option to replace (e.g., delete and re-record) the previously recorded track (e.g., while keeping and/or playing back the newly recorded track) and/or to mix the previously recorded track with the newly recorded track. In one or more implementations, after the recording of the new track has been completed, a user interface 1100 (e.g., another screen of the user interface 600, such as another screen of the user interface of the application 501) may provide a listing of stored recordings (e.g., stored in the memory 171). As shown in FIG. 11, the user interface 1100 may include a multi-track recording indicator 1101 for any of the stored recordings that include multiple tracks. In one or more implementations, the user interface 1100 may also include a settings element 1103. FIG. 12 illustrates an example of a user interface 1200 that may be displayed following selection of the settings element 1103. As shown, selection of the settings element 1103 may result in display of various playback setting options for the multi-track recording, including playback speed, silence skipping, and/or balancing of an amount of each of the multiple tracks to be included in playback of the multi-track recording.

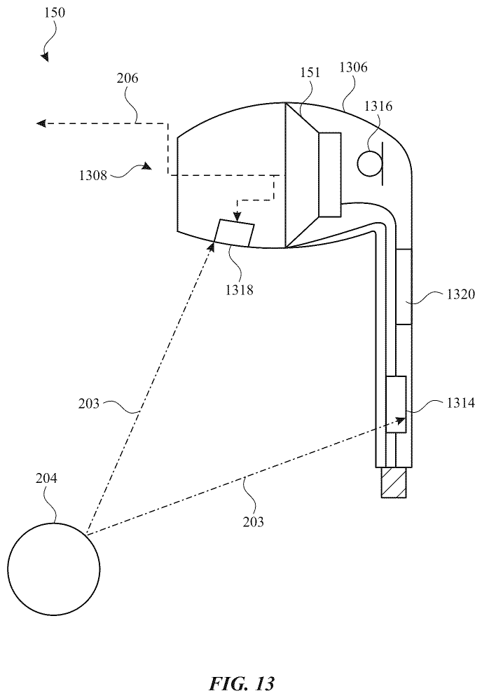

In the examples of FIGS. 2-5 above, the multi-track recording operations are described as being performed by the electronic device 104. However, it is appreciated that the multi-track recording operations may also, or alternatively, be performed by one or more other electronic devices. As one additional illustrative example, FIG. 13 illustrates the audio output device 150 performing multi-track recording operations. As shown in FIG. 13, the audio output device 150 may be implemented as an earbud. In this example, a housing 1306 of the audio output device 150 is shaped for seating in the user's concha and for interfacing with the user's car canal. In one or more implementations, the earbud of FIG. 13 may include processing circuitry 1320 that performs one or more of the multi-track recording operations described herein. In one or more other implementations, the earbud of FIG. 13 may be used in conjunction with another electronic device, such as a smartphone or tablet computer (e.g., electronic device 104) to which microphone signals received by microphones, such as microphones 1314, 1316, and/or 1318 (e.g., implementations of the microphones 152) of FIG. 1), may be transmitted and/or from which audio output signals (e.g., track 207) for the speaker 151 may be received.

Aspects of the subject technology described herein may be performed by one or more processors of the earbud of FIG. 13, and/or may be performed by a processor inside a smartphone or tablet computer, upon receiving the microphone signals from a wired or wireless data communication link with the earbud of FIG. 13. In one or more implementations, a speaker 151 of the audio output device 150 may generate the audio output 206 that is based on the track 207 described herein in connection with FIGS. 2, 3, 4, and/or 5. The track 207 may be stored at the audio output device 150, or received from a companion device, such as the electronic device 104. As shown, the audio output 206 may be projected from an opening 1308 in the housing 1306, and may also be received, as audio input, by one or more microphones of the audio output device, including by the microphone 1318 that is nearest to the speaker 151.

In this example, the sound 203 from the sound source 204 may be received by the microphone 1318 and the microphone 1314. In one or more implementations, the processing circuitry 1320 may perform the echo-cancellation operations of the processing block 212 (e.g., using an input signal from the microphone 1318 as a reference signal for cancelling audio content corresponding to the audio output 206 from the input signal generated by the microphone 1314), the residual echo cancellation operations of the processing block 500, and/or the multi-track recording operations of the processing block 502, to generate the track 209 and/or a multi-track recording 503.

In one or more implementations, the sound 203 may also be received by the microphone 1316. The processing circuitry 1320 may perform the masking operations of masking block 302 and/or mixing block 306 of FIG. 3, using the audio input from the microphone 1316, as was described herein in connection with the microphone 174-3 and the masking block 302 of FIG. 3.

Although an example is shown in FIG. 13 in which the audio output device 150 is implemented as an earbud, in other implementations, the audio output device 150 may be implemented as headphones including a pair of earcups that are configured to be placed over the user's ears. In the example of FIG. 13, the audio output device 150 includes a speaker 151, a top microphone (e.g., microphone 1316) whose sound sensitive surface faces a direction that is opposite the eardrum of the user when the earbud is worn, a bottom microphone (e.g., microphone 1314) that is located in or near an end portion of the housing 1306 of the earbud where it is the closest microphone to the user's mouth, and an error microphone 1318 that senses the sound at or near the user's eardrum (e.g., in the user's ear canal). In the example of FIG. 13, the error microphone 1318 may be in a position and orientation to receive an output from the speaker 151 and/or one or more other sounds, such as the sound 203.

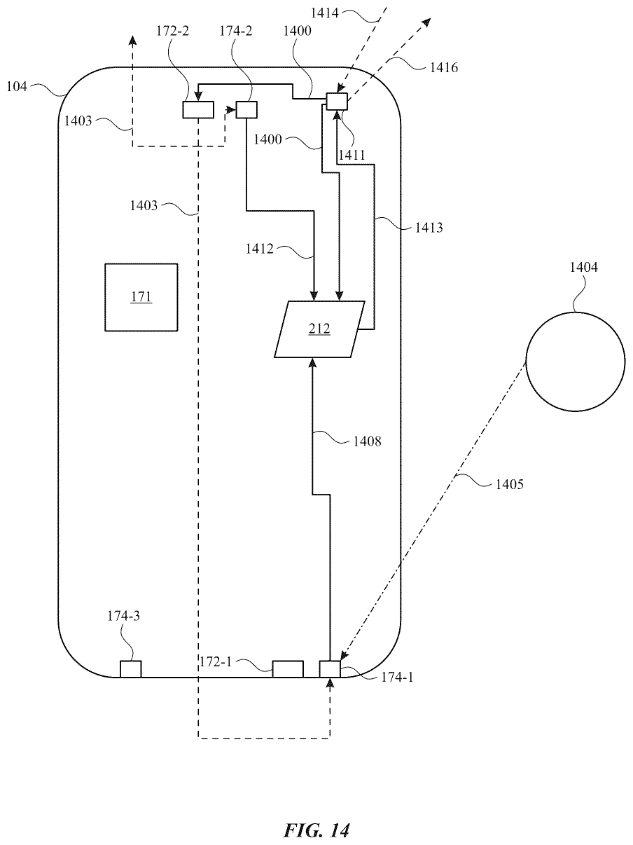

As discussed herein, the processing block 212 may be implemented as an echo canceller (e.g., implemented in hardware, software, or a combination thereof, such as by a digital signal processor) that can perform other echo cancellation functions for the electronic device in which it is implemented (e.g., the electronic device 104 or the audio output device 150). For example, FIG. 14 illustrates a use case in which the processing block 212 that is used for multi-track recording is, in a separate use case, used for echo cancellation during a telephony operation (e.g., a telephone call or other audio or video conference). In the example of FIG. 14, communications circuitry 1411 of the electronic device 104 is used to receive remote signals 1414 that encode audio from a remote caller, and the transmit outgoing (e.g., uplink) signals that encode local audio to the remote caller.

As shown, an audio signal 1400 that is based on the incoming remote signals 1414 may be provided for output by the speaker 172-2 (e.g., and/or other speakers of the electronic device), such as without storing the audio output signal 1400 in memory 171 or other memory at the electronic device 104. As shown, the speaker 172-2 may generate an audio output 1403 corresponding to the audio signal 1400, and the audio output 1403 may be received by the microphone 174-2, and by the microphone 174-1 that also receives sound 1405 (e.g., a voice of the user 101) from a sound source 1404 (e.g., the user 101). In this example, the processing block 212 may use an audio input 1412 generated by the microphone 174-2 responsive to receiving the audio output 1403 (e.g., and/or may use the audio output signal 1400 received in the remote signal 1414) as a reference signal to cancel a portion of an audio signal 1408 that corresponds to the audio output 1403. In this way, uplink audio 1413 may be generated that includes only (or substantially only) the sound 1405 (e.g., the voice of the user) for transmission in the outgoing (e.g., uplink) signals 1416. In this way, the multi-track recording operations of FIGS. 2-5 may be performed efficiently by using existing echo cancellation capabilities of the electronic device 104.

In the example of FIG. 14, the remote signal 1414 is used to generate an output from a speaker 172-2 for a telephony operation. However, it is also appreciated that, in one or more use cases in which the processing block 212 is used for multi-track recording, one or more of the tracks may be received from a remote device, such as in a remote signal 1414 (e.g., in a use case in which a user of the electronic device 104 wishes to collaboratively generate a multi-track recording with a remote user). In such use cases, a remote track received in a remote signal 1414 may be output by the speaker(s) 172 in real time while the local user of the electronic device 104 records their own input track using the microphone(s) 174, or the remote track received in the remote signal 1414 may be stored at the electronic device 104 (e.g., in the memory 171) for later output by the speaker(s) 172 while the local user of the electronic device 104 records their own input track using the microphone(s) 174. In these use cases, an audio track based on the remote signal 1414 may be stored by the electronic device 104, and the sound generated by the speaker(s) 172 based on the remote signal 1414 while the local user records their own input track using the microphone(s) 174 may be removed (e.g., canceled and/or suppressed as discussed herein in connection with previously recorded tracks) from the microphone signals for recording of the local user's track.

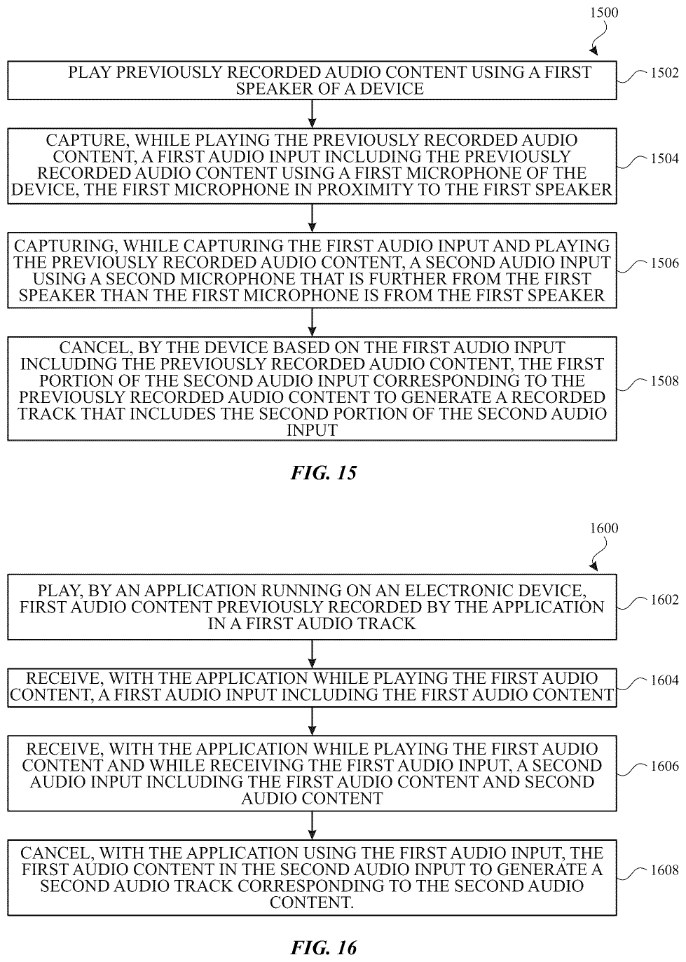

FIG. 15 illustrates a flow diagram of an example process 1500 for multi-track recording, in accordance with implementations of the subject technology. For explanatory purposes, the process 1500 is primarily described herein with reference to the electronic device 104 of FIG. 1. However, the process 1500 is not limited to the electronic device 104 of FIG. 1, and one or more blocks (or operations) of the process 1500 may be performed by one or more other components of other suitable devices and/or servers. Further for explanatory purposes, some of the blocks of the process 1500 are described herein as occurring in serial, or linearly. However, multiple blocks of the process 1500 may occur in parallel. In addition, the blocks of the process 1500 need not be performed in the order shown and/or one or more blocks of the process 1500 need not be performed and/or can be replaced by other operations.

As illustrated in FIG. 15, at block 1502, a device (e.g., electronic device 104) may play (e.g., output) previously recorded audio content (e.g., track 207) using a first speaker (e.g., speaker 172-1) of the device. In one or more implementations, the device may include a handheld electronic device, such as a smartphone. For example, the previously recorded audio content may have been previously recorded by the device.

At block 1504, while playing the previously recorded audio content, the device may capture, using a first microphone (e.g., microphone 174-1) of the device, a first audio input (e.g., audio input 208) that includes the previously recorded audio content. The first microphone may be in proximity to the first speaker.

At block 1506, while capturing the first audio input and playing the previously recorded audio content, the device may capture a second audio input (e.g., audio input 210) using a second microphone (e.g., microphone 174-2) that is further from the first speaker than the first microphone is to the first speaker. The second audio input may include a first portion corresponding to the previously recorded audio content, and a second portion different from the previously recorded audio content (e.g., the second portion corresponding to the sound 203). In one illustrative example, the previously recorded audio content includes music played by a user of the device, and the second portion of the second audio input includes a voice of the user or another user. In one or more implementations, a second speaker (e.g., speaker 172-2) of the device may be muted (e.g., or otherwise inactivated or prevented from generating output) while playing the previously recorded audio content using the first speaker of the device. The second microphone may be in proximity to the second speaker.

In one or more implementations, the first speaker may include a bottom speaker of the device, the second speaker may include a top speaker of the device, the first microphone may include a bottom microphone of the device that is nearer to the bottom speaker than to the top speaker, and the second microphone may include a top microphone of the device that is nearer to the top speaker than to the bottom speaker.

At block 1508, the device (e.g., processing block 212) may remove (e.g., cancel), based on the first audio input (e.g., audio input 208) that includes the previously recorded audio content (e.g., track 207), the first portion of the second audio input (e.g., audio input 210) corresponding to the previously recorded audio content to generate a recorded track (e.g., track 209) that includes the second portion (e.g., corresponding to the sound 203) of the second audio input. In one or more implementations, the process 1500 may also include capturing, while capturing the first audio input and the second audio input and while playing the previously recorded audio content, a third audio input using a third microphone (e.g., microphone 174-3) of the device, and generating a mask (e.g., mask 304) based on the third audio input. Removing (e.g., canceling) the first portion of the second audio input corresponding to the previously recorded audio content may include removing (e.g., canceling) the first portion of the second audio input corresponding to the audio content based on the first audio input while preserving the second portion of the second audio input using the mask (e.g., as shown in FIG. 3). In one or more implementations, the removing (e.g., canceling) may include performing (e.g., by the processing block 212) an echo cancelation on the second audio input using the first audio input, and the process 1500 may also include suppressing (e.g., by processing block 500, such as by a machine learning model) a residual echo of the first portion of the second audio input.

In one or more implementations, the previously recorded audio content includes a previously recorded first track (e.g., track 207), the recorded track comprises a second track (e.g., track 209), and the process 1500 also includes combining (e.g., by processing block 502) the previously recorded first track and the second track in a multi-track recording (e.g., multi-track recording 503). In one or more implementations, the process 1500 may also include providing (e.g., in a user interface, such as user interface 600), by the device after generating the recorded track, an option (e.g., option 1000) to replace the previously recorded first track. In one or more implementations, the process 1500 may also include providing (e.g., in a user interface, such as user interface 600), by the device, a controller (e.g., controller 1202) for controlling relative amounts of the previously recorded first track and the second track in the multi-track recording.

In one or more implementations, the playing of block 1502, the capturing of the first audio input at block 1504, the capturing of the second audio input at block 1506, and the removing (e.g., canceling) at block 1508 may be performed by a single application (e.g., application 501) at the device.

FIG. 16 illustrates a flow diagram of another example process 1600 for multi-track recording in accordance with implementations of the subject technology. For explanatory purposes, the process 1600 is primarily described herein with reference to the electronic device 104 of FIG. 1. However, the process 1600 is not limited to electronic device 104 of FIG. 1, and one or more blocks (or operations) of the process 1600 may be performed by one or more other components of other suitable devices and/or servers. Further for explanatory purposes, some of the blocks of the process 1600 are described herein as occurring in serial, or linearly. However, multiple blocks of the process 1600 may occur in parallel. In addition, the blocks of the process 1600 need not be performed in the order shown and/or one or more blocks of the process 1600 need not be performed and/or can be replaced by other operations.

In the example of FIG. 16, at block 1602, an application (e.g., application 501) running on an electronic device (e.g., electronic device 104) may play (e.g., output via a speaker of the electronic device) first audio content previously recorded by the application in a first audio track (e.g., track 207). In one or more implementations, the first audio content was previously recorded by the application using at least a first microphone (e.g., microphone 174-1, 174-2, and/or 174-4) of the electronic device, and playing the first audio content includes playing the first audio content via a first speaker (e.g., speaker 172-1) of the electronic device. In one or more implementations, a second speaker (e.g., speaker 172-2) of the electronic device may be muted (e.g., or otherwise inactivated or prevented from playing the first audio content) while playing the first audio content with the first speaker of the electronic device.

At block 1604, the application may receive, while playing the first audio content, a first audio input (e.g., audio input 208) including the first audio content. In one or more implementations, receiving the first audio input includes receiving the first audio input via the first microphone of the electronic device.

At block 1606, the application may receive, while playing the first audio content and while receiving the first audio input, a second audio input (e.g., audio input 210) including the first audio content and second audio content. In one or more implementations, receiving the second audio input includes receiving the second audio input via a second microphone (e.g., microphone 174-2) of the electronic device.

At block 1608, the application may remove (e.g., cancel), using the first audio input, the first audio content in the second audio input to generate a second audio track (e.g., track 209) corresponding to the second audio content. In one or more implementations, the application may also provide (e.g., in a user interface 600), after generating the second audio track, an option (e.g., option 1000) to replace the first audio track. In one or more implementations, the application may also provide, after generating the second audio track, a controller (e.g., controller 1202, such as a slider) for controlling relative amounts of the first audio track and the second audio track in a multi-track recording.

In one or more implementations, the application may also (e.g., to record an additional track, such as a third audio track), play a multi-track audio output including the first audio track with the first audio content and the second audio track with the second audio content. The application may also receive, while playing the multi-track audio output, a third audio input including the first audio content and the second audio content. The application may also receive, while playing the multi-track audio output and while receiving the third audio input, a fourth audio input including the first audio content, the second audio content, and third audio content. The application may also remove (e.g., cancel), with the application using the third audio input, the first audio content and the second audio content in the third audio input to generate a third audio track corresponding to the third audio content.

As described above, one aspect of the present technology is the gathering and use of data available from specific and legitimate sources for multi-track recording. The present disclosure contemplates that in some instances, this gathered data may include personal information data that uniquely identifies or can be used to identify a specific person. Such personal information data can include audio data, voice samples, voice profiles, voice streams, demographic data, location-based data, online identifiers, telephone numbers, email addresses, home addresses, biometric data or records relating to a user's health or level of fitness (e.g., vital signs measurements, medication information, exercise information, motion information, workout information), date of birth, or any other personal information.

The present disclosure recognizes that the use of such personal information data, in the present technology, can be used to the benefit of users. For example, the personal information data can be used for multi-track recording.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominently and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations which may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates aspects in which users selectively block the use of, or access to, personal information data. That is, the present disclosure contemplates that hardware and/or software elements can be provided to prevent or block access to such personal information data. For example, in the example of multi-track recording, the present technology can be configured to allow users to select to “opt in” or “opt out” of participation in the collection and/or sharing of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level or at a scale that is insufficient for facial recognition), controlling how data is stored (e.g., aggregating data across users), and/or other methods such as differential privacy.

Therefore, although the present disclosure broadly covers use of personal information data to implement one or more various disclosed implementations, the present disclosure also contemplates that the various implementations can also be implemented without the need for accessing such personal information data. That is, the various implementations of the present technology are not rendered inoperable due to the lack of all or a portion of such personal information data.

FIG. 17 illustrates an electronic system 1700 with which one or more implementations of the subject technology may be implemented. The electronic system 1700 can be, and/or can be a part of, the audio output device 150, the display device 123, the media output device 115, the speaker device 127, the electronic device 104, and the server(s) 120 as shown in FIG. 1. The electronic system 1700 may include various types of computer readable media and interfaces for various other types of computer readable media. The electronic system 1700 includes a bus 1708, one or more processing unit(s) 1712, a system memory 1704 (and/or buffer), a ROM 1710, a permanent storage device 1702, an input device interface 1714, an output device interface 1706, and one or more network interfaces 1716, or subsets and variations thereof.

The bus 1708 collectively represents all system, peripheral, and chipset buses that communicatively connect the numerous internal devices of the electronic system 1700. In one or more implementations, the bus 1708 communicatively connects the one or more processing unit(s) 1712 with the ROM 1710, the system memory 1704, and the permanent storage device 1702. From these various memory units, the one or more processing unit(s) 1712 retrieves instructions to execute and data to process in order to execute the processes of the subject disclosure. The one or more processing unit(s) 1712 can be a single processor or a multi-core processor in different implementations.

The ROM 1710 stores static data and instructions that are needed by the one or more processing unit(s) 1712 and other modules of the electronic system 1700. The permanent storage device 1702, on the other hand, may be a read-and-write memory device. The permanent storage device 1702 may be a non-volatile memory unit that stores instructions and data even when the electronic system 1700 is off. In one or more implementations, a mass-storage device (such as a magnetic or optical disk and its corresponding disk drive) may be used as the permanent storage device 1702.

In one or more implementations, a removable storage device (such as a floppy disk, flash drive, and its corresponding disk drive) may be used as the permanent storage device 1702. Like the permanent storage device 1702, the system memory 1704 may be a read-and-write memory device. However, unlike the permanent storage device 1702, the system memory 1704 may be a volatile read-and-write memory, such as random access memory. The system memory 1704 may store any of the instructions and data that one or more processing unit(s) 1712 may need at runtime. In one or more implementations, the processes of the subject disclosure are stored in the system memory 1704, the permanent storage device 1702, and/or the ROM 1710 (which are each implemented as a non-transitory computer-readable medium). From these various memory units, the one or more processing unit(s) 1712 retrieves instructions to execute and data to process in order to execute the processes of one or more implementations.

The bus 1708 also connects to the input and output device interfaces 1714 and 1706. The input device interface 1714 enables a user to communicate information and select commands to the electronic system 1700. Input devices that may be used with the input device interface 1714 may include, for example, alphanumeric keyboards and pointing devices (also called “cursor control devices”). The output device interface 1706 may enable, for example, the display of images generated by electronic system 1700. Output devices that may be used with the output device interface 1706 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 17, the bus 1708 also couples the electronic system 1700 to one or more networks and/or to one or more network nodes through the one or more network interface(s) 1716. In this manner, the electronic system 1700 can be a part of a network of computers (such as a LAN, a wide area network (“WAN”), or an Intranet, or a network of networks, such as the Internet. Any or all components of the electronic system 1700 can be used in conjunction with the subject disclosure.

These functions described above can be implemented in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (also referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; e.g., feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; e.g., by sending web pages to a web browser on a user's client device in response to requests received from the web browser.

Aspects of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and may interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. The described functionality may be implemented in varying ways for each particular application. Various components and blocks may be arranged differently (e.g., arranged in a different order, or partitioned in a different way) all without departing from the scope of the subject technology.

It is understood that the specific order or hierarchy of steps in the processes disclosed is an illustration of example approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the invention described herein.

The predicate words “configured to”, “operable to”, and “programmed to” do not imply any particular tangible or intangible modification of a subject, but, rather, are intended to be used interchangeably. For example, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

The term automatic, as used herein, may include performance by a computer or machine without user intervention; for example, by instructions responsive to a predicate action by the computer or machine or other initiation mechanism. The word “example” is used herein to mean “serving as an example or illustration.” Any aspect or design described herein as “example” is not necessarily to be construed as preferred or advantageous over other aspects or designs.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an “embodiment” may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a “configuration” may refer to one or more configurations and vice versa.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112 (f), unless the element is expressly recited using the phrase “means for” or, in the case of a method claim, the element is recited using the phrase “step for”.

What is claimed is:

1. A method, comprising:
playing previously recorded audio content using a first speaker of a device;
capturing, while playing the previously recorded audio content, a first audio input comprising the previously recorded audio content using a first microphone of the device, the first microphone in proximity to the first speaker;
capturing, while capturing the first audio input and playing the previously recorded audio content, a second audio input using a second microphone that is further from the first speaker than the first microphone is from the first speaker, wherein the second audio input includes a first portion corresponding to the previously recorded audio content and a second portion different from the previously recorded audio content; and
removing, by the device based on the first audio input comprising the previously recorded audio content, the first portion of the second audio input corresponding to the previously recorded audio content to generate a recorded track that includes the second portion of the second audio input.

2. The method of claim 1, wherein the previously recorded audio content comprises music played by a user of the device, and wherein the second portion of the second audio input includes a voice of the user or another user.

3. The method of claim 1, further comprising muting a second speaker of the device while playing the previously recorded audio content using the first speaker of the device, wherein the second microphone is in proximity to the second speaker.

4. The method of claim 3, wherein the first speaker comprises a bottom speaker of the device, the second speaker comprises a top speaker of the device, the first microphone comprises a bottom microphone of the device that is nearer to the bottom speaker than to the top speaker, and wherein the second microphone comprises a top microphone of the device that is nearer to the top speaker than to the bottom speaker.

5. The method of claim 4, further comprising:
capturing, while capturing the first audio input and the second audio input and while playing the previously recorded audio content, a third audio input using a third microphone of the device; and
generating a mask based on the first audio input and the third audio input,
wherein removing the first portion of the second audio input corresponding to the previously recorded audio content comprises removing the first portion of the second audio input corresponding to the audio content based on the first audio input while preserving the second portion of the second audio input using the mask.

6. The method of claim 1, wherein the previously recorded audio content includes a previously recorded first track, the recorded track comprises a second track, and the method further comprises combining the previously recorded first track and the second track in a multi-track recording.

7. The method of claim 6, further comprising providing, by the device after generating the recorded track, an option to replace the previously recorded first track.

8. The method of claim 6, further comprising providing, by the device, a controller for controlling relative amounts of the previously recorded first track and the second track in the multi-track recording.

9. The method of claim 1, wherein the removing comprises performing an echo cancelation on the second audio input using the first audio input, and wherein the method further comprises suppressing a residual echo of the first portion of the second audio input.

10. The method of claim 1, wherein the device comprises a handheld electronic device.

11. The method of claim 10, wherein the handheld electronic device comprises a smartphone.

12. The method of claim 1, wherein the playing, the capturing of the first audio input, the capturing of the second audio input, and the removing are performed by a single application at the device.

13. A method, comprising:
playing, by an application running on an electronic device, first audio content previously recorded by the application in a first audio track;
receiving, with the application while playing the first audio content, a first audio input including the first audio content;
receiving, with the application while playing the first audio content and while receiving the first audio input, a second audio input including the first audio content and second audio content; and
removing, with the application using the first audio input, the first audio content in the second audio input to generate a second audio track corresponding to the second audio content.

14. The method of claim 13, further comprising, with the application:
playing a multi-track audio output including the first audio track with the first audio content and the second audio track with the second audio content;
receiving, with the application while playing the multi-track audio output, a third audio input including the first audio content and the second audio content;
receiving, with the application while playing the multi-track audio output and while receiving the third audio input, a fourth audio input including the first audio content, the second audio content, and third audio content; and
removing, with the application using the third audio input, the first audio content and the second audio content in the third audio input to generate a third audio track corresponding to the third audio content.

15. The method of claim 13, further comprising providing, with the application after generating the second audio track, an option to replace the first audio track.

16. The method of claim 13, further comprising providing, with the application after generating the second audio track, a controller for controlling relative amounts of the first audio track and the second audio track in a multi-track recording.

17. The method of claim 13, wherein:
the first audio content was previously recorded by the application using at least a first microphone of the electronic device,
playing the first audio content comprises playing the first audio content via a first speaker of the electronic device,
receiving the first audio input includes receiving the first audio input via the first microphone of the electronic device; and
receiving the second audio input includes receiving the second audio input via a second microphone of the electronic device.

18. The method of claim 17, further comprising muting a second speaker of the electronic device while playing the first audio content with the first speaker of the electronic device.

19. A device, comprising:
a first speaker;
a first microphone in proximity to the first speaker;
a second microphone that is further from the first speaker than the first microphone is to the first speaker;
a memory storing previously recorded audio content; and
one or more processors configured to:
play the previously recorded audio content using the first speaker;
capture, while playing the previously recorded audio content, a first audio input comprising the previously recorded audio content using the first microphone;
capture, while capturing the first audio input and playing the previously recorded audio content, a second audio input using the second microphone, wherein the second audio input includes a first portion corresponding to the previously recorded audio content and a second portion different from the previously recorded audio content; and
remove, based on the first audio input comprising the previously recorded audio content, the first portion of the second audio input corresponding to the previously recorded audio content to generate a recorded track that includes the second portion of the second audio input.

20. The device of claim 19, further comprising a second speaker in proximity to the second speaker, wherein the one or more processors are further configured to mute the second speaker while playing the previously recorded audio content using the first speaker of the device.
